(19) United States
(12) Patent Application Publication
(10) Pub. No.: US 2008/0040283 A1
(43) Pub. Date: Feb. 14, 2008

(54) CONTENT PROTECTION SYSTEM AND METHOD FOR ENABLING SECURE SHARING OF COPY-PROTECTED CONTENT

(75) Inventor: Steven Morris, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ARCADYAN TECHNOLOGY CORPORATION, Hsinchu (TW)

(21) Appl. No.: 11/463,906

(22) Filed: Aug. 11, 2006

(51) Int. Cl. G06Q 99/00

(52) U.S. Cl. 705/59

(57) ABSTRACT

A content protection system for enabling secure sharing of a piece of content encrypted for copy-protection and a method therefor. The system includes a first processing unit and a license management unit. The first processing unit is for enabling the first user to send a request for sharing the piece of content with at least a second user. The license management unit, in response to the request, is used for generating a second license file for the second user which is associated with the first license file, the piece of content, and the second user, wherein the second license file securely includes a second decryption key needed to decrypt the piece of content and restrictions on the piece of content with respect to the second user. The second user is authorized to use a shared copy of the piece of content according to the restrictions in the second license file.

### BACKGROUND OF THE INVENTION

1. Field of the Invention

The invention relates in general to a digital rights management system and a method therefor, and more particularly to a content protection system and method for enabling secure sharing of copy-protected content.

2. Description of the Related Art

Digital rights management (DRM) systems are commonplace when buying digital content today—online stores such as Apple's iTunes Music Store uses DRM technology to prevent unauthorized copying of songs, and it is becoming increasingly common for many kinds of downloaded media, such as, audio clips, videos, movies, and documents. Some operating systems, for example, Microsoft Windows XP operating systems, include support for DRM, for use with portable players and when streaming content to other devices

Under a DRM system, users who have purchased rights to use content, such as a song, are only able to listen to DRM-encrypted copies of the song themselves. Content owners provide the users licenses for the content. When a user who has purchased rights to a song wishes to listen to the DRM-encrypted copy of the song for oneself, the player device of the user retrieves license information associated with the user to decrypt the encrypted copy so as to play the song. Since a third party has no rights or license information to decrypt the encrypted copy of the song, the third party cannot play the encrypted copy.

As such, a user who has license to use content may not share the encrypted content with a third party, for example, a friend. This restriction is desirable for content owners to prevent copyrighted copies from being distributed illegally and reduce the loss of revenue due to illegal use of the copyrighted copies.

However, people tend to share or recommend content that they are using and fond of to the others. A user might only share content with other people by giving them their license information, and this is often a security risk. Besides, the conventional DRM prevents some of the more traditional ways of promoting music, based on recommendations from friends or other people with similar preferences. Content owners may regard promotion by their authorized users as a positive action towards their business. However, the conventional DRM systems lack effective and secure solutions to meet these needs of both the users and content owners.

### SUMMARY OF THE INVENTION

It is therefore an object of the invention to provide a content protection system for enabling secure sharing of copy-protected digital content and a method therefor. One piece of content and a first license file is associated with a first user. The first license file securely includes a first decryption key needed to decrypt the content and restrictions on the piece of content with respect to the first user. The first user is authorized to use the piece of content according to the restrictions in the first license file.

According to one aspect of the invention, a content protection system for enabling secure sharing of a piece of content which is encrypted for copy-protection is provided. The system includes a first processing unit and a license management unit. The first processing unit is for enabling the first user to send a request for sharing the piece of content with at least a second user, wherein the request includes identification information of the second user and the piece of content. The license management unit, in response to the request, is used for generating a second license file for the second user which is associated with the first license file, the piece of content, and the second user, wherein the second license file securely includes a second decryption key needed to decrypt the piece of content and restrictions on the piece of content with respect to the second user. The second user is authorized to use a shared copy of the piece of content according to the restrictions in the second license file.

According to another aspect of the invention, a content protection method for enabling secure sharing of a piece of content which is encrypted for copy-protection is provided. The method includes the following steps. (a) a request for sharing the piece of content with at least a second user is sent, wherein the request includes identification information of the second user and the piece of content. (b) in response to the request, a second license file is generated for the second user which is associated with the first license file, the piece of content, and the second user, wherein the second license file securely includes a second decryption key needed to decrypt the piece of content and restrictions on the piece of content with respect to the second user. The second user is authorized to use a shared copy of the piece of content according to the restrictions in the second license file.

According to another aspect of the invention, a license management apparatus is provided for use in a content protection system for enabling secure sharing of a piece of content which is encrypted for copy-protection. The license management apparatus includes a storage device and a management unit. The storage device is used for storing license information including information corresponding to the first license file. The management unit is in response to a request for sharing the piece of content with at least a second user, wherein the request includes identification information of the second user and the piece of content. The management unit is used for generating a second license file for the second user which is associated with the first license file, the piece of content, and the second user, according to the first license file and the request. The second license file securely includes a second decryption key needed to decrypt the piece of content and restrictions on the piece of content with respect to the second user. The second user is authorized to use a shared copy of the piece of content according to the restrictions in the second license file.

Other objects, features, and advantages of the invention will become apparent from the following detailed description of the preferred but non-limiting embodiments. The following description is made with reference to the accompanying drawings

### BRIEF DESCRIPTION OF THE DRAWINGS

FIG. 1 shows a diagram illustrating a content protection system for enabling secure sharing of copy-protected content according to an embodiment of the invention.

FIG. 2 shows a flowchart of a content protection method for enabling secure sharing of copy-protected content according to an embodiment of the invention.

### DETAILED DESCRIPTION OF THE INVENTION

According to an embodiment of the invention, in a content protection system for enabling secure sharing of copy-protected content with others, a first user who has rights to use a piece of content can share the piece of content with a second user, e.g. a friend, by submitting a request for sharing to the content owner to create a new license for the second user to use a shared copy of the piece of content. After the content owner creates the new license, the second user may request for the license information with respect to the second user where the license information describes restrictions on the piece of the content with respect to the second user. According to the license information in the new license, the second user is authorized to use the shared copy of the piece of content, e.g. to play a song or video, or to read a text file or a picture, depending on the type of the content

In this way, encrypted files of content may be copied freely, for example, either given directly to the recipient from the sharer, or via a peer-to-peer application program, but a license is still needed to play the content.

In the above embodiment, the content owner may operate a network service, such as a content store or a web site, including a license management unit which is responsible for creating a license and/or a new license, and, for example, operates in a license server. The network service may be a service with an address which can be reached in a wireless and/or wired-network, e.g. a web site in the Internet or a service in a digital wireless phone network. In view of implementation, actions of “content owner” described in the embodiments of the invention can also be regarded as implemented by, for example, a network service, a license management unit, or a software module, in an interactive manner or automatic manner. In addition, the first user, for example, uses a processing unit, such as a computer system, a handheld device, or a mobile phone, to send a request for sharing copy-protected content. Hence, the content protection system including a processing unit and a license management unit, as described above, provides a new license for a third party to use the piece of content.

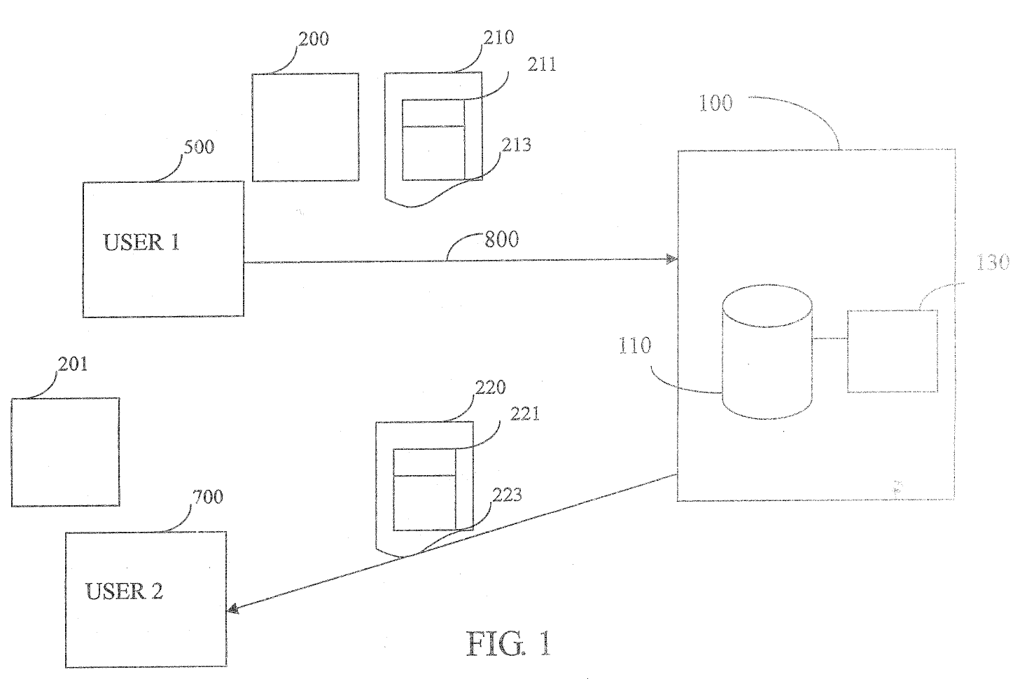

More specifically, a content protection system is shown in FIG. 1 for enabling secure sharing of a piece of content 200 which is encrypted for copy-protection, according to an embodiment of the invention. The system includes a license server 100, a first processing unit 500 for a first user, and a second processing unit 700 for a second user. The piece of content 200 and a first license file 210 is associated with the first user, who may use the first processing unit 500, such as a personal computer, a handheld device, or a portable playing device, to communicate with the license server 100. The first license file 210 securely includes a first decryption key 211 needed to decrypt the content 200 and restrictions 213 on the piece of content 200 with respect to the first user, the first user is authorized to use the piece of content 200 according to the restrictions 213 in the first license file 210.

The piece of content which is information, e.g. text, audio, picture, or video, or any combination thereof, encrypted, and may include some information about where to obtain a license for that content, for example, a specific web-site address. The license server 100, which authenticates a user and stores information about what actions the user can carry out with respect to the content, such as play, copy, and any other restrictions that may apply: e.g. play only 30 times; play for a period of 7 days, do not play over digital outputs. The license server 100, for example, includes a storage device 110 for storing license information and a management unit 130, for example, a programmed processor, for performing license management operations, such as creating a license for a user. A license file, which securely includes information Of these actions and restrictions, and a decryption key needed to decrypt a piece of content.

The first users by using the first processing unit 500, sends a request 800 for sharing the piece of content with at least a second user, wherein the request includes identification information of the second user and the piece of content 200. In response to the request 800, the license server 100 generates a second license file 220 for the second user which is associated with the first license file 210, the piece of content 200, and the second user, wherein the second license file 220 securely includes a second decryption key 221 needed to decrypt the piece of content 200 and restrictions 223 on the piece of content 200 with respect to the second user. The second user is authorized to use a shared copy 201 of the piece of content 200 according to the restrictions 223 in the second license file 220.

The second user, for example, uses the second processing unit 700 to retrieve the second license file 220 in order to use, e.g. play, the shared copy 201 of the piece of content.

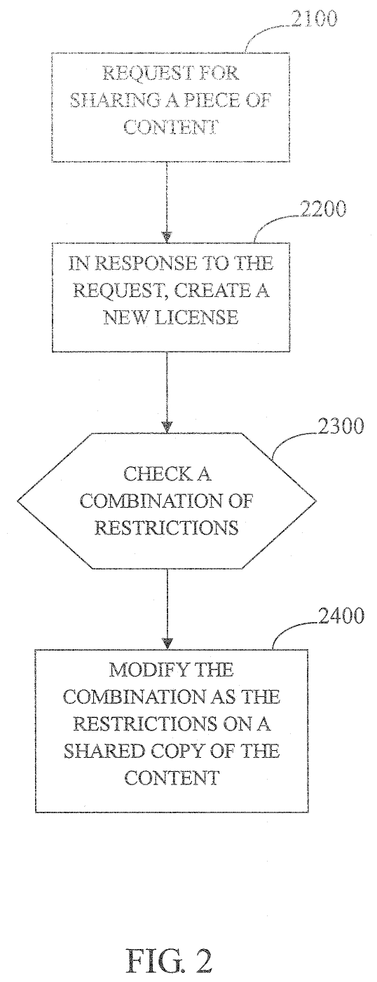

FIG. 2 shows a flowchart of a content protection method for enabling secure sharing of copy-protected content according to another embodiment of the invention. In this embodiment, a providing limited access to DRM-encrypted content is achieved in the content protection system based on FIG. 1.

Initially, the first user, for Clarity, is named as a sharer, and the second user is named as a recipient. Both the sharer and recipient have their user accounts on the same content service, for example, an online music store,

In step 2100, the sharer, e.g. through a processing unit, issues a request to share content to the license owner, for example, via the content owner's web page or online store or via the sharer's content library application. This request includes the following information: (a) the identification (ID) of the user with whom content will be shared, (b) the ID(s) of the content to be shared, (c) any restrictions that the sharer imposes on that content.

In step 2200, the content owner creates one or more new licenses for the recipient, with each new license associated with one piece of shared content. These licenses include all of the restrictions originally imposed on the content, for example, but also any restrictions imposed on the shared copy by the sharer. For instance, the sharer may have the right to play a track unlimited times, but may choose to limit the shared copy to be played a finite number of times, 10, for example.

In step 2300, the content owner checks a combination of the restrictions, and modifies them if necessary to meet their business rules, as indicated in step 2400. These modifications will prevent the content from being shared too widely. Typical restrictions, for example, may include at least one of the following. (a) Duplicating the shared copy of the content is prohibited, (b) The license for the shared copy is only valid for playing the shared copy a finite number of times or for a limited period, which may be lower than that specified by the sharer. (c) Only a low-quality copy of the content may be played. For example, if the content is a song in MP3 format at a bit rate of 128 kb/s, the shared copy of the song may be played or is at a bit rate of a lower bit rate, such as 64 kb/s.

Proceeding to step 2200, the content owner may choose to limit shared copies to be played up to a lower number of times, e.g. 5 times, thus overriding the looser restrictions (e.g. maximum 10 times) imposed by the sharer.

Additionally, the content owner adds a field to the license that indicates that the license is a shared copy. This field contains the ID of the sharer and is used for billing purposes on pay-per-view content.

When the recipient wishes to play the shared content, for example, by the second processing unit 700, indicated in FIG. 1, the following steps are taken. Firstly, the second processing unit 700 playing the content retrieves the second license 220 for the content and checks the licenses belonging to both the sharer and the recipient.

If the time limit has expired on either the sharer's license or the recipient's license, then the recipient is informed that the content can no longer be played and invited to purchase their own license.

If the sharer or the recipient is not only allowed to pay the content a certain number of times, and that limit has been reached, then the recipient is informed that the content can no longer be played and invited to purchase their own license. Otherwise, the number of times for playing remaining is decremented or reduced by a number for both the sharer and the recipient.

If the content is pay-per-view content, the cost of the content is removed from the sharer's account. For pre-paid accounts where not enough credit is available, the recipient is informed that the content cannot be played at this time and invited to purchase their own license.

According to the above disclosed embodiments, a user is allowed to provide ‘preview’ copies of content to other user while all of the rights for the content owner are retained, with no loss of revenue. Encrypted files of content may be copied freely, for example, either given directly to the recipient from the sharer, or via a peer-to-peer application program, but a license is still needed to play the content.

By using a combined set of license restrictions imposed by the content owner and the sharer, there is no loss of revenue for the content owner, and for example, the content owners can track who has shared a piece of content, while sharers can limit use of their account information for content playback and billing. Further, a business model such as promotion and pay-view-pay can be built on the secure sharing. In addition, the new license is tied to the original license, and so any metering features of the license will also be applied to the new content. This also enables the content owner to track distribution of the content. Therefore, as illustrated in the above embodiments, the content protection system fulfils the needs of the users to share content and the needs of content owners for copy protection and allowance for promotion.

While the invention has been described by way of example and in terms of embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A content protection system for enabling secure sharing of a piece of content which is encrypted for copy-protection, wherein the piece of content and a first license file is associated with a first user, and the first license file securely includes a first decryption key needed to decrypt the content and restrictions on the piece of content with respect to the first user, the first user is authorized to use the piece of content according to the restrictions in the first license file, the system comprising:
a first processing unit for enabling the first user to send a request for sharing the piece of content with at least a second user, wherein the request includes identification information of the second user and the piece of content;
a license management unit, in response to the request, for generating a second license file for the second user which is associated with the first license file, the piece of content, and the second user, wherein the second license file securely includes a second decryption key needed to decrypt the piece of content and restrictions on the piece of content with respect to the second user; and
wherein the second user is authorized to use a shared copy of the piece of content according to the restrictions in the second license file.

2. The content protection system according to claim 1, wherein the request from the first processing unit further includes restrictions that the first user imposes on the piece of content.

3. The content protection system according to claim 2, wherein the license management unit creates the second license file, wherein the restrictions on the piece of content with respect to the second user are according to the restrictions on the piece of content with respect to the first user.

4. The content protection system according to claim 3, wherein the restrictions on the piece of content with respect to the second user are according to the restrictions on the piece of content with respect to the first user and the restrictions that the first user imposes on the piece of content.

5. The content protection system according to claim 4, wherein the restrictions on the piece of content with respect to the second user is a combination of the restrictions on the piece of content with respect to the first user and the restrictions that the first user imposes on the piece of content.

6. The content protection system according to claim 5, wherein the license management unit further makes the restrictions on the piece of content with respect to the second user to include a restriction that duplicating the shared copy of the piece of content is prohibited.

7. The content protection system according to claim 5, wherein the license management unit further makes the restrictions on the piece of content with respect to the second user to include a restriction that the second license file is only valid for playing the piece of content a finite number of times.

8. The content protection system according to claim 5, wherein the license management unit further makes the restrictions on the piece of content with respect to the second user to include a restriction that the second license file is only valid for a limited period.

9. The content protection system according to claim 5, wherein the license management unit further makes the restrictions on the piece of content with respect to the second user to include a restriction that only a low-quality copy of the piece of content may be played.

10. The content protection system according to claim 1, wherein the license management unit creates the second license file, wherein the restrictions on the piece of content with respect to the second user are according to the restrictions on the piece of content with respect to the first user.

11. The content protection system according to claim 1, wherein the license management unit further makes the restrictions on the piece of content with respect to the second user to include a restriction that duplicating the shared copy of the piece of content is prohibited.

12. The content protection system according to claim 1, wherein the license management unit further makes the restrictions on the piece of content with respect to the second user to include a restriction that the second license file is only valid for playing the piece of content a finite number of times.

13. The content protection system according to claim 1, wherein the license management unit further makes the restrictions on the piece of content with respect to the second user to include a restriction that the second license file is only valid for a limited period.

14. The content protection system according to claim 1, wherein the license management unit further makes the restrictions on the piece of content with respect to the second user to include a restriction that only a low-quality copy of the piece of content may be played.

15. The content protection system according to claim 14, wherein the identification information of the first user in the second license file is used for billing purposes on pay-per-view content.

16. The content protection system according to claim 1, wherein the second license file includes indication that the second license is a license for a shared copy and includes identification information of the first user.

17. A content protection method for enabling secure sharing of a piece of content which is encrypted for copy-protection, wherein the piece of content and a first license file is associated with a first user, and the first license file securely includes a first decryption key needed to decrypt the content and restrictions on the piece of content with respect to the first user, the first user is authorized to use the piece of content according to the restrictions in the first license file, the method comprising,
(a) sending a request for sharing the piece of content with at least a second user, wherein the request includes identification information of the second user and the piece of content;
(b) in response to the request, generating a second license file for the second user which is associated with the first license file, the piece of content and the second user, wherein the second license file securely includes a second decryption key needed to decrypt the piece of content and restrictions on the piece of content with respect to the second user; and
wherein the second user is authorized to use a shared copy of the piece of content according to the restrictions in the second license file.

18. The content protection method according to claim 17, wherein the request from the first processing unit further includes restrictions that the first user imposes on the piece of content.

19. The content protection method according to claim 18, wherein in step (a), the restrictions on the piece of content with respect to the second user are according to the restrictions on the piece of content with respect to the first user.

20. The content protection method according to claim 19, wherein in step (b), the restrictions on the piece of content with respect to the second user are according to the restrictions on the piece of content with respect to the first user and the restrictions that the first user imposes on the piece of content.

21. The content protection method according to claim 20, wherein in step (b), the restrictions on the piece of content with respect to the second user is a combination of the restrictions on the piece of content with respect to the first user and the restrictions that the first user imposes on the piece of content.

22. The content protection method according to claim 21, wherein in step (b), the license management unit further makes the restrictions on the piece of content with respect to the second user to include a restriction that duplicating the shared copy of the piece of content is prohibited.

23. The content protection method according to claim 21, wherein the license management unit further makes the restrictions on the piece of content with respect to the second user to include a restriction that the second license file is only valid for playing the piece of content a finite number of times.

24. The content protection method according to claim 21, wherein the license management unit further makes the restrictions on the piece of content with respect to the second user to include a restriction that the second license file is only valid for a limited period.

25. The content protection method according to claim 21, wherein the license management unit further makes the restrictions on the piece of content with respect to the second user to include a restriction that only a low-quality copy of the piece of content may be played.

26. The content protection method according to claim 17, wherein the license management unit further makes the restrictions on the piece of content with respect to the second user to include a restriction that duplicating the shared copy of the piece of content is prohibited.

27. The content protection method according to claim 17, wherein the license management unit further makes the restrictions on the piece of content with respect to the second user to include a restriction that the second license file is only valid for playing the piece of content a finite number of times.

28. The content protection method according to claim 17, wherein the license management unit further makes the restrictions on the piece of content with respect to the second user to include a restriction that the second license file is only valid for a limited period.

29. The content protection method according to claim 17, wherein the license management unit further makes the restrictions on the piece of content with respect to the second user to include a restriction that only a low-quality copy of the piece of content may be played.

30. The content protection method according to claim 17, wherein the second license file includes indication that the second license is a license for a shared copy and includes identification information of the first user.

31. The content protection method according to claim 30, wherein the identification information of the first user in the second license file is used for billing purposes on pay-per-view content.

32. The content protection method according to claim 17, wherein in step (a), the restrictions on the piece of content with respect to the second user are according to the restrictions on the piece of content with respect to the first user.

33. A license management apparatus for use in a content protection system for enabling secure sharing of a piece of content which is encrypted for copy-protection, wherein the piece of content and a first license file is associated with a first user, and the first license file securely includes a first decryption key needed to decrypt the content and restrictions on the piece of content with respect to the first user, the first user is authorized to use the piece of content according to the restrictions in the first license file, the license management apparatus:
a storage device for storing license information including information corresponding to the first license file;
a management unit, in response to a request for sharing the piece of content with at least a second user, wherein the request includes identification information of the second user and the piece of content, the management unit being for generating a second license file for the second user which is associated with the first license file, the piece of content, and the second user, according to the first license file and the request, wherein the second license file securely includes a second decryption key needed to decrypt the piece of content and restrictions on the piece of content with respect to the second to user, and
wherein the second user is authorized to use a shared copy of the piece of content according to the restrictions in the second license file.
